(19) United States
(12) Patent Application Publication
(10) Pub. No.: US 2004/0226637 A1
(43) Pub. Date: Nov. 18, 2004

(54) Method, system and article employing laser shock processing of threads and keyways

(75) Inventors: Jeff L. Dulaney, Dublin, OH (US); Allan H. Clauer, Worthington, OH (US); Steven M. Toller, Grove City, OH (US)

Correspondence Address: RANDALL J. KNUTH P.C., 3510-A STELLHORN ROAD, FORT WAYNE, IN, 46815-4631, US

(73) Assignee: LSP Technologies, Inc.

(21) Appl. No.: 10/437,690

(22) Filed: May 13, 2003

(51) Int. Cl. B23K 26/00

(52) U.S. Cl. 148/903; 219/121.6; 219/121.85

(57) ABSTRACT

A laser shock processing treatment is employed to condition the mating surfaces of various fastener elements, such as screws, bolts, splines, keys, and keyways. In a screw, for example, the threaded surface is laser shock processed to form laser shock processed surfaces at the thread root portion of the screw. Regions of compressive residual stresses imparted by laser shock processing are thereby formed and extend into the screw body from the laser shock processed surfaces. In a keyway, for example, the keyway surface is laser shock processed to form laser shock processed surfaces within the keyway. Regions of compressive residual stresses imparted by laser shock processing are thereby formed and extend into the keyway body from the laser shock processed surfaces. The compressive residual stress regions enhance the rigidity and torsional stiffness of the fastener elements and improve their fatigue properties.

### BACKGROUND OF THE INVENTION

1. Field of the invention.

The present invention relates to a method, system and article of manufacture employing laser shock processing technology, and, more particularly, to the laser shock treatment of fasteners and other attachment devices, such as the engagement-type mating surfaces of threads and keyways.

2. Description of the related art.

Industrial equipment and common machinery typically employ a variety of fastening mechanisms for securing parts together. These mechanisms commonly are needed to ensure that parts remain secured together in fixed relationship to one another during machine operation. For example, a gear may be annularly disposed about a shaft in a fixed relative position by the use of a raised key element disposed axially on the shaft. The gear hub would be formed with a complementary mating-type feature (e.g., a groove-type keyway) that fits about the shaft key. In this manner, the keyway-key-keyway (for example, the shaft with a keyway, key, and gear with a keyway) combination enables the gear and drive shaft to remain in proper angular relationship to one another and also to facilitate the transfer of torque from the shaft to the gear.

One category of fasteners includes devices configured to inhibit relative motion between parts. For example, keys, pins and retainers may be used to prevent relative rotational motion between parts. Additionally, these devices may restrain relative axial movement between parts. Other types of fasteners may be used to simply secure cooperating parts together, if not for the purpose of preventing relative movement. For example, components such as threaded screws and bolts are commonly used to attach different pieces of machinery together.

One problem that undermines the durability of fasteners, particularly in high-stress environments, involves their continued exposure to torquing pressures and other bending or stretching moments that may compromise the integrity of the fastener structure. In particular, for fasteners such as keys and pins that serve the added purpose of facilitating the transfer of torque between cooperating parts, the fasteners require an inherent strength capable of withstanding the constant or cyclically applied torque loads that are communicated through the fastener.

If a fatigue crack develops anywhere in a fastener due to a defect, excessive loading, or insufficient resistance to torquing, the incipient flaw will enlarge and propagate to other regions of the fastener before eventually causing catastrophic failure of the fastener, e.g., total breakage. Depending upon the application, failure of a fastener may lead to more significant damage elsewhere in the machine environment, particularly if the fastener is used to connect moving parts.

A need therefore exists to improve the fatigue properties of fasteners and other such attachment devices, especially those used in a machine environment and heavy-duty industrial applications.

A need exists further to develop a treatment process that has the capacity to provide full and precise surface coverage of the fastener surface or surfaces subjected to loading.

A need exists further to develop a treatment process that is especially adapted to fastener geometries having abrupt contours and small or tight dimensional profiles, which otherwise make it difficult to directly access and precisely treat certain surface features.

### SUMMARY OF THE INVENTION

According to the present invention, there is provided a method, system and article of manufacture directed to fasteners and other forms of attachment and connection devices that exhibit improved fatigue properties and strength due to a laser shock processing treatment.

As used herein, references to fasteners should be construed as encompassing, without limitation, any device or structure of whatever form that serves the purpose of facilitating a connection or coupling relationship between two or more parts, such as matable complementary parts. For example, this connection may serve to fix the relationship between respective parts or otherwise secure the relative position or location of adjoining parts.

Examples of fasteners may include, but are not limited to, screws, bolts, nuts, keys, keyways, pins, ring/C clips, retainers, pin/holw press fit connections, and splines. Moreover, in one form, fasteners may be construed for this application to include one or both of a male member and a corresponding female member that have a complementary mating-type correspondence with one another. For example, one type of matable male-female combination could include a screw with an external threaded surface and a corresponding nut-type cylinder having an internal threaded surface that meshes in a known fashion with the male threaded surface (e.g., a complementary mating-type engagement). Anything could be pillow block bearing or other interlocking style interface.

Fasteners, in another form, may be considered to include any combination of matable first and second element typically 3 elements for key-keyway, regardless of whether the elements have male and/or female characteristics. For example, a fastener may include one or both of the matable structures of a key-keyway combination, i.e., the key device and the corresponding keyways in which the key is disposed. Fasteners may also encompass an assembly having a combination of plural matable parts. For ease of discussion, this application will focus on and describe the keyways for processing, but this is not meant to limit the invention. Similarly, keys may be processed in a corresponding fashion.

Moreover, in another form, fasteners should be understood as encompassing any device, structure or geometrical form that bears or possesses a fastening feature or structure and which may form part of an overall structure having a functionality distinct from the fastening objective. For example, a vehicle spark plug has a threaded external surface (e.g., fastener) that facilitates a seal-type engagement and placement of the spark plug within the cylinder head so that the electrode tip may be suitably disposed for access into the combustion chamber. Accordingly, the invention may be practiced on devices such as spark plugs and other functional components that have a fastening feature or structure (e.g., a threaded surface).

Furthermore, in another form, fasteners should be understood as encompassing any mechanism having attachment capabilities or features (e.g., threaded surface), but which itself has a distinct purpose that is facilitated by the threading connection, for example. For example, in an aircraft, the actuation of an MD-80 jackscrew mechanism is used to move or manipulate the stabilizer wing. Accordingly, the invention may be practiced on devices such as a jackscrew mechanism having a fastener-type feature.

Additionally, in another form, fasteners should be understood as encompassing attachment mechanisms that serve purposes in addition to providing a means for connecting, mating, or securing parts together. For example, certain fasteners may be used to inhibit certain types of relative motion between parts. A key-keyway combination, for example, may be used as an anti-rotational device that prevents relative angular movement between a drive shaft and an attached gear, so that these parts move in unison with one another. Moreover, a pin may be used as an anti-translational device that inhibits and/or prevents relative translational motion between connected parts. For example, a pin may be used to prevent axial displacement of a gear or pulley relative to a drive shaft to which these components are mounted in driving relationship.

Furthermore, in another form, fasteners should be understood as encompassing any structural feature that accommodates or facilitates a fastening function, although by itself it does not necessarily constitute a discrete device. For example, the fastening structure may be formed in one of the mechanical parts or machine components intended for interconnection. Accordingly, the fasteners disclosed herein may include a combination of discrete mating parts (e.g., a male-female thread arrangement), a discrete fastener mated to a corresponding fastening feature formed in one of the machine parts (e.g., a spark plug threaded into a threaded bore formed in a vehicle cylinder head), or a combination of matable fastener structures each defined or formed in respective machine parts (e.g., a keyway defined in a shaft to receive a key defined in a gear hub).

In particular, a recessed keyway having a groove-type structure, for example, may be formed along the longitudinal dimension of a shaft to receive a corresponding ridge-type key formed in a gear hub. Additionally, a screw-receiving fastener may be provided in the form of an internally-threaded cylindrical bore that is formed within the body of a mechanical part.

In one form of the invention, a laser shock processing treatment is used in connection with fasteners having threaded surfaces, such as screws and bolts. According to the treatment procedure the thread root is laser shock processed to produce corresponding laser shock processed surfaces on the threaded fastener at the thread root. As a result, in one form, a helical or spiral-type pattern of laser shock processed surfaces is provided along the root surface line of the fastener threaded surface. The laser shock processing treatment is preferably performed at least along the full extent of the fastener threaded surface that is subject to fatigue, fretting, corrosion cracking, or wear failure in service.

In one form of the invention, a laser shock processing treatment is used in connection with fasteners having threaded surfaces, such as screws and bolts. According to the treatment procedure, the thread is laser shock processed to produce corresponding laser shock processed surfaces on the threaded fastener. As a result, in one form, a helical or spiral-type pattern of laser shock processed surfaces is provided along the fastener surface. The laser shock processing treatment is preferably performed along the fastener surface that is subject to potential fatigue, fretting, corrosion cracking, or wear failure in service.

As a result of the laser shock processing treatment, there is formed in the fastener plural regions of deep compressive residual stresses that extend into the body of the fastener from the laser shock processed surfaces. Accordingly, these regions of compressive residual stress are generally located at and adjacent to the root portion of the threaded surface.

In another form of the invention, a laser shock processing treatment is used in connection with keyway structures. According to the treatment procedure, at least a portion of the keyway surface is laser shock processed to produce corresponding laser shock processed surfaces. For example, the resting or slide surface, or the internal corners of a keyway may be laser shock processed along a portion of the key-keyway mating engagement.

As a result of the laser shock processing treatment, there is formed in the keyway plural regions of deep compressive residual stresses that extend into the body of the keyway from the laser shock processed surfaces.

The invention, in one form thereof, is directed to a treatment method that involves providing a workpiece having a threaded surface, and laser shock processing at least one thread root portion of the workpiece.

In one form, the laser shock processing operation involves laser shock processing the thread root portion to facilitate the formation of at least one region of compressive residual stresses each extending into the workpiece from a respective laser shock processed surface thereof.

In various forms, the workpiece may define a screw, a bolt, a male member having an external threaded surface, and/or a female member having an internal threaded surface, or a connection member, surface or artifact.

The invention, in another form thereof, is directed to a treatment method that involves providing a workpiece having a threaded surface, and forming at least one laser shock processed surface each disposed at least in part at a respective thread root portion of the workpiece.

In one form, the treatment method further involves the formation of at least one region of compressive residual stresses imparted by laser shock processing, wherein each compressive residual stress region extends into the workpiece from a respective laser shock processed surface thereof.

The invention, in another form thereof, is directed to a treatment method that involves providing a workpiece having a threaded surface, and causing the formation of at least one region of compressive residual stresses each extending into the workpiece at a respective thread root portion of the workpiece.

In one form, the regions of compressive residual stress are formed by laser shock processing the workpiece.

The invention, in another form thereof, is directed to a method for use with a workpiece having a threaded surface. The method involves providing a laser shock processor, and operating the laser shock processor to laser shock process at least one thread root portion of the workpiece.

In one form, the operation of the laser shock processor is configured to facilitate the formation of at least one region of compressive residual stresses each extending into the workpiece from a respective laser shock processed surface thereof.

The invention, in another form thereof, is directed to a treatment method that involves providing a workpiece having a threaded surface, and laser shock processing the workpiece at at least one thread trough portion of the workpiece threaded surface.

In one form, the laser shock processing operation is configured to laser shock process at least one thread root portion of the workpiece to thereby form at least one laser shock processed surface. Moreover, the laser shock processing operation is configured further to cause the formation of at least one region of compressive residual stresses imparted by laser shock processing, wherein each compressive residual stress region extends into the workpiece at a respective thread root portion of the workpiece.

The invention, in another form thereof, is directed to a system for use with a workpiece having a threaded surface. The system includes, in combination, a laser shock processing apparatus and a controller to selectably control operation of the laser shock processing apparatus. The controller is configured to direct the laser shock processing apparatus to laser shock process at least one thread root portion of the workpiece.

The invention, in another form thereof, is directed to a system for use with a workpiece having a threaded surface. The system includes, in combination, a laser shock processing apparatus and a controller to selectably control operation of the laser shock processing apparatus. The controller is configured to direct the laser shock processing apparatus to laser shock process the workpiece to form at least one laser shock processed surface each disposed at least in part at a respective threaded surface of the workpiece.

The invention, in another form thereof, is directed to an article having a threaded surface. The article includes at least one laser shock processed surface each disposed at least in part at a respective thread root portion of the article. The article further includes at least one region each having compressive residual stresses imparted by laser shock processing, wherein each region extends into the article from a respective laser shock processed surface.

In various forms, the article includes at least one of a male member having an external threaded surface, a female member having an internal threaded surface, a bolt, and a screw.

The invention, in another form thereof, is directed to a treatment method that involves providing a workpiece having a keyway, and laser shock processing at least a portion of the workpiece keyway.

In one form, the laser shock processing operation involves laser shock processing the workpiece keyway to form at least one laser shock processed surface thereof and to form at least one region of compressive residual stresses imparted by laser shock processing. Each such region extends into the workpiece from a respective laser shock processed surface.

The invention, in another form thereof, is directed to a treatment method that involves providing a workpiece having a keyway, and forming at least one laser shock processed surface each disposed at least in part within the workpiece keyway.

In one form, the formation of the laser shock processed surfaces also forms at least one region of compressive residual stresses imparted by laser shock processing. Each such region extends into the workpiece from a respective laser shock processed surface thereof.

The invention, in another form thereof, is directed to a treatment method that involves providing a workpiece having a keyway with a surface, and laser shock processing the workpiece at the keyway surface thereof to form at least one laser shock processed surface and to form at least one region of compressive residual stresses imparted by laser shock processing. Each such region extends into the workpiece from a respective laser shock processed surface thereof.

The invention, in another form thereof, is directed to a system for use with a workpiece having a keyway. The system includes, in combination, a laser shock processing apparatus and a controller to selectably control operation of the laser shock processing apparatus. The controller is configured to direct the laser shock processing apparatus to laser shock process the workpiece keyway.

In one form, the laser shock processing operation is configured to facilitate the formation of at least one region of compressive residual stresses each extending into the workpiece from a respective laser shock processed surface thereof.

The invention, in another form thereof, is directed to a system for use with a workpiece having a keyway. The system includes, in combination, a laser shock processing apparatus and a controller to selectably control operation of the laser shock processing apparatus. The controller is configured to direct the laser shock processing apparatus to laser shock process the workpiece to form at least one laser shock processed surface each disposed at least in part within the workpiece keyway.

The invention, in another form thereof, is directed to an article having a keyway. The article includes at least one laser shock processed surface each disposed at least in part within the keyway of the article. The article further includes at least one region each having compressive residual stresses imparted by laser shock processing. Each such region extends into the article from a respective laser shock processed surface.

The invention, in another form thereof, is directed to a method for use with an assembly having a combination of matable parts, wherein each matable part has a respective mating surface. The method involves laser shock processing at least a portion of the mating surface of at least one matable part.

In one form, the assembly includes a workpiece having a threaded surface. Furthermore, the laser shock processing operation involves laser shock processing at least one thread root portion of the workpiece.

In another form, the assembly includes a workpiece having a keyway. Furthermore, the laser shock processing operation involves laser shock processing at least a portion of the workpiece keyway.

The invention, in another form thereof, is directed to an article having a combination of matable parts, wherein each matable part has a respective mating surface. The article includes at least one laser shock processed surface each disposed at least in part at a respective mating surface of a respective matable part. The article further includes at least one region each having compressive residual stresses imparted by laser shock processing. Each such region extends into the article from a respective laser shock processed surface.

In one form, the article further includes at least one matable part each having a threaded surface with at least one laser shock processed surface formed at a thread thereof.

In another form, the article further includes at least one matable part each having a keyway with at least one laser shock processed surface formed therein.

One advantage of the present invention is that the matable parts of a fastener arrangement can now be provided with improved fatigue properties due to the laser shock processing treatment.

Another advantage of the invention is that the laser shock processing treatment increases the torsional strength of fasteners to thereby improve the torque-transfer connection.

Another advantage of the present invention is that fastener elements having surface geometries with sharp discontinuities, abrupt contours, small dimensional profiles, and other relatively inaccessible surfaces can now be successfully treated with laser shock processing treatments.

Another advantage of the present invention is that the use of laser shock processing technology is especially suited to the treatment of fastener devices not only because laser processing can provide the needed strength improvements (i.e., via the introduction of compressive residual stresses), but because the laser-based treatment steps are compatible with the small dimensions of fasteners, since laser processing normally involves the precise delivery of high-intensity impulse energy needed to properly implement a shock processing operation.

Another advantage of the invention is that the use of laser shock processing technology not only provides the fatigue improvements arising from processing treatments, but also draws upon the advantages which stem from using laser communications to deliver the treatment energy, namely, the ability to precisely control the laser beam and thereby tailor the size of the laser beam spots to the dimensional requirements, specifications, and constraints of the fastener target surface.

Another advantage of the invention is that the durability and longevity of machine environments can be improved since the invention may be practiced on fasteners that serve the added purpose of maintaining the integrity of the torque-transferring connection between cooperating power-delivery components, i.e., a shaft and a gear or pulley; and of maintaining the mechanical integrity of the machine or structure.

Another advantage of the invention is that the safety margin of certain critical components has been increased, such as the stabilizer wing of aircraft, since the invention may be practiced on an MD-80 jackscrew type mechanism used to move a stabilizer, for example.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a partial fragmentary cross-sectional view of one illustrative type of thread pattern that is subject to laser shock processing, in order to illustrate one form of the invention;

FIG. 2 is a partial fragmentary upper elevational perspective view of the thread pattern in FIG. 1 taken along cross-sectional lines A-A′;

FIG. 3 is a partial fragmentary cross-sectional view of another illustrative type of thread pattern that is subject to laser shock processing, in order to illustrate one form of the invention;

FIG. 4 is a partial fragmentary upper planar sectional view of the thread pattern in FIG. 3 taken along a representative thread line direction;

FIG. 5 is an axial side sectional planar view of a threaded assembly depicting a combination of matable parts that may be used in connection with practicing the invention;

FIG. 6 is an axial end planar view depicting a keyway structure formed in a shaft, in order to illustrate another form of the invention;

FIG. 7 is a partial fragmentary upper planar view of the keyway structure shown in FIG. 6 taken along its longitudinal dimension; and

FIG. 8 is a partial schematic, partial block diagram illustration of an exemplary laser shock processing system for use in practicing the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

By way of background, reference is first made to FIG. 8 to briefly describe laser shock processing. Laser processing (or laser shock processing) is a laser-based treatment that involves subjecting a workpiece to a laser shock processing activity so as to induce the formation of deep compressive residual stresses in the workpiece. The formation of compressive residual stress regions arises from the propagation of traveling compressional shock waves that impinge against and then pass into the workpiece.

Referring to FIG. 8, there is shown a schematic diagram of one illustrative laser processing system 100 for use in practicing the invention. According to one illustrative process configuration, a transparent overlay applicator 132 and an opaque overlay applicator 134 are employed to respectively apply a transparent overlay material (e.g., water) and an opaque overlay material (e.g., black paint) to the surface of workpiece 124. The transparent overlay is preferably substantially transparent to laser radiation, while the opaque overlay is preferably opaque to laser radiation.

During processing, a laser beam 122 generated by laser 120 is directed towards workpiece 124, passing through the transparent overlay and then being absorbed by the opaque overlay, e.g., black paint. This absorption causes the rapid vaporization of the opaque overlay and the consequent formation of a high-energy plasma that is confined to a region adjacent the workpiece surface.

As the plasma expands from the vaporization area, it creates a compressional shockwave traveling into the material from the workpiece surface, thereby developing a processing effect that “cold works” the surface. As this shockwave penetrates and travels into the workpiece, it induces the formation of deep compressive residual stresses that extend into the workpiece from the laser shock processed surface.

A controller 128 controls the operation and timing of each of the applicators 132, 134 and laser 120, and selective operation of part positioning mechanism 126 to ensure proper sequencing, synchronization, coordination and timing of the various components of laser processing system 110.

Further descriptions of laser processing may be found in reference to U.S. Pat. Nos. 5,741,559, 5,911,890, 6,292,584, and 6,483,076, which are each in their entirety incorporated herein by reference thereto and which are assigned to the same assignee as the present application.

The present invention, in one form, generally relates to the use of a laser shock processing procedure to treat the mating surfaces of at least one component of an assembly including plural matable fastener elements. In one such assembly, for example, the combination of fastener elements serves at least to provide a securing or fastening function that facilitates the attachment, engagement, connection or coupling of machine parts. The fasteners may provide other functional purposes, such as assisting in the torque-transfer connection between certain machine parts. Examples of fasteners include thread-type elements and keyway-type elements, although the invention may be practiced with other fastener structures.

Examples of thread-type fasteners include, but are not limited to, acme threads, square threads, modified square threads, buttress threads, and ball bearing screw threads. These thread-type fasteners may be found in any of various screws and bolts, for example. Examples of keyway-type fasteners include, but are not limited to, keyways that are used in conjunction with appropriate keys, pins and retainers to secure elements such as gears or pulleys to shafts so that torque can be transferred between them. Additionally, the keyway-type fasteners may be used to prevent certain types of relative motion between the mating parts, e.g., relative axial and/or rotational motion.

Moreover, the invention may be practiced in connection with any of various applications, such as medical screws, splines, keyways, and drive screws, e.g., machine tools such as lathes and mills. Other uses may include bolts and/or screws for applications directed to aircraft such as fixed wing, helicopters and engines (e.g., an MD-80 jackscrew); automotive (e.g., drive train); machinery (e.g., construction or production equipment); farm equipment (e.g., tractors and combines); boats (e.g., drive train); and weapons systems (e.g., tanks and guns). The enumeration of these applications is merely illustrative and should not be considered in limitation of the invention, as it should be apparent that the invention may be practiced in connection with other applications and fields of use.

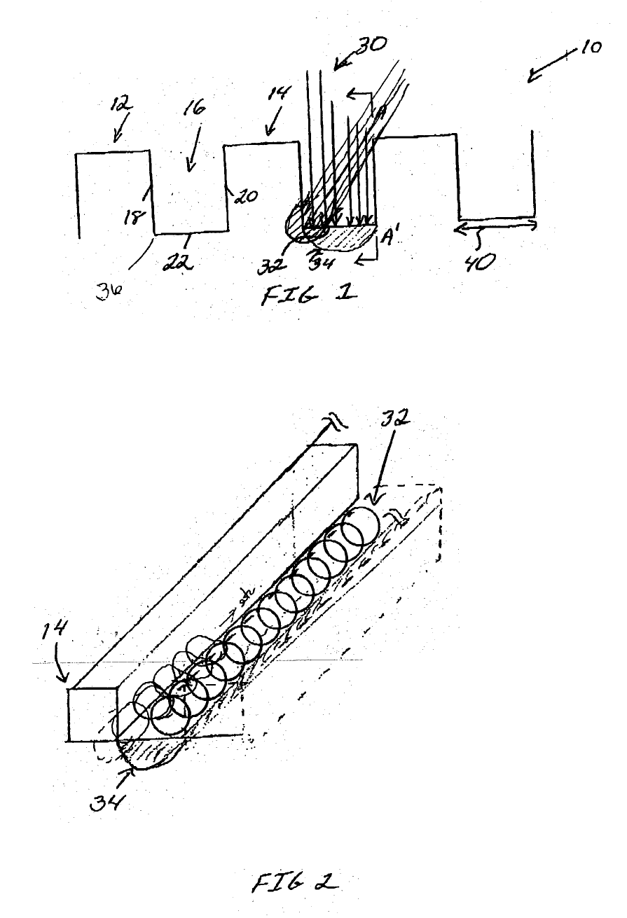

Referring now to the drawings and particularly to FIG. 1, there is shown a fragmentary, cross-sectional profile view of a square-type thread pattern 10 (e.g., acme thread) that is subject to a laser shock processing treatment, according to one form of the invention. This thread pattern 10 may form part of the threaded surface of a screw or bolt, for example.

As conventionally known, the surface contour of thread pattern 10 typically includes a series of adjacent thread ridges 12 and 14 defining a trough portion 16 therebetween. Trough 16 is defined by sidewalls or flanks 18 and 20 that are joined by the thread root, namely, bottom surface 22.

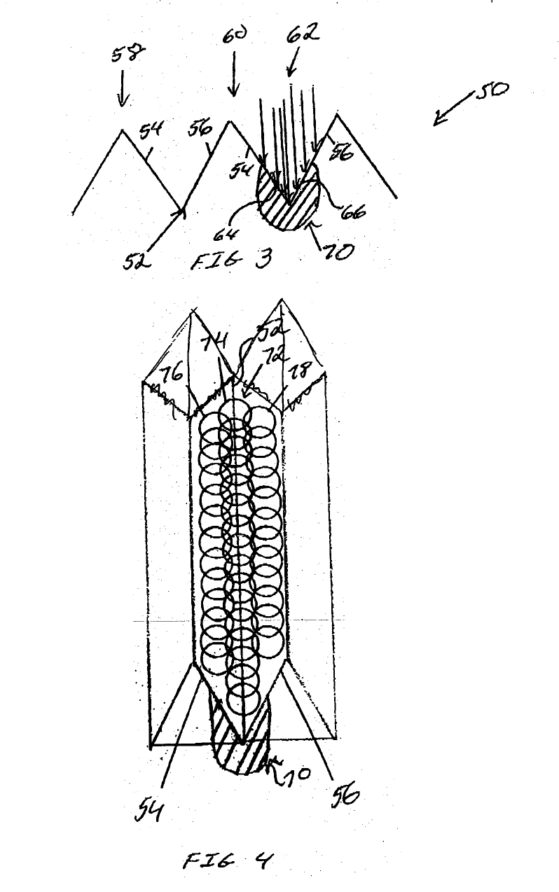

According to the invention, the thread root (i.e., thread bottom surface 22) is laser shock processed using a suitable laser shock processing treatment, as illustrated by the collection of representative laser beams 30 irradiating bottom surface 22. Referring to FIG. 2, there is shown a fragmentary cross-sectional perspective view of thread pattern 10 taken along lines A-A′ in FIG. 1, to illustrate the effects of the laser shock processing treatment.

Generally, as used herein, thread root has a conventional understanding and should be considered as encompassing, for example, that portion of the threaded surface where the opposing flanks of adjacent thread ridges meet, join, or otherwise interface with or transition to one another along with the corner edges of the bottom surface. For example, in FIG. 1, the thread root of the illustrated square-type threaded surface is defined by bottom surface 22, while in FIG. 3 the thread root of the sawtooth-type threaded surface depicted therein is defined by an abrupt surface line or edge. In this case, the fatigue critical region associated with the thread root would be the corners 36 along the edges of surface 22 which act as stress risers. Therefore, corners 36 would be laser shock processed as shown (30′) in FIG. 1. Surface 22 would be laser shock processed alone if fretting fatigue or wear of the surface was a problem.

In particular, as shown in FIG. 2, a plurality of laser shock processed surfaces 32 are formed on bottom surface 22 (i.e., the thread root) corner 36 and side 18 using an appropriate pattern of laser beam spots in a laser shock processing operation. Preferably, the laser shock processed surfaces 32 form a line or sequence of contiguous processed surfaces to provide full or substantially full coverage of the thread root.

Although the processed surfaces 32 are shown as overlapping, it may be possible to use any type of laser beam spot pattern. Additionally, the frequency of laser shock processing may be controlled. For example, multiple cycles of laser shock processing may be used to repeatedly process the same threaded surface. It should be apparent that any conventional sequence of process steps may be undertaken to complete the laser shock processing operations described herein. For example, any suitable masking or selective irradiation technology may be utilized to specifically target the thread root for processing treatment. It may be possible, as well, to laser shock process the entire threaded surface (e.g., the entire thread ridge), in addition to the thread root.

Referring to FIG. 1, the laser shock processing of thread root bottom surface 22, corner 36 and sidewall 18 by laser beams 30 and 30′ induces the formation of regions of deep compressive residual stresses 34 that extend into the main body of the threaded element (e.g., screw) from the laser shock processed surface 32 in addition to sidewall 18. As a result, the threaded body exhibits improved fatigue properties and enhanced torsional strength at the thread root. Preferably, the entire thread root surface including the adjacent corners are laser shock processed so that continuous regions of compressive residual stresses are formed at the thread root and stress concentration areas. An illustration of such contiguous stress regions is depicted in FIG. 2. Moreover, the penetration depth and profile of stress region 34 may be tailored and otherwise adjusted to meet certain design criteria by appropriate control of the laser shock processing parameters, as known to those skilled in the art.

One of the advantages of adapting laser shock processing technology to its use in treating part geometries such as the thread pattern of FIG. 1 is that very small and otherwise inaccessible dimensional areas can be accessed by the relatively smaller laser beam medium. In FIG. 1, for example, the root diameter 40 typically is of such narrow dimension that it becomes difficult if not impossible to fully access the thread root using non-laser shot process media having dimensions on the same (or greater) order of magnitude of the thread root diameter. Even if such non-laser shot process media can access the thread root, it typically cannot extend the processing all the way down to and into the apex of the thread root where the thread root is joined to the thread flank.

However, in the invention, the laser beam spot sizes and directions can be conventionally controlled to a dimension and location that enables the laser beam to fully irradiate the entire thread root and adjacent corner (FIG. 1, beam 30′). For example, in FIG. 2, the laser beam spot is sized, dimensioned, and otherwise tailored to cover the breadth of the thread root and the adjacent corner. Alternately, instead of a single spot, several smaller laser beam spots can be used to irradiate across the entire width of the thread root. The invention therefore recognizes and takes advantage of the comparatively smaller dimensional scale of laser beam spots to accomplish full coverage laser shock processing treatment of the thread root.

In particular, the laser beam spots can be sized and dimensionally/geometrically tailored to a dimension/shape that is less than (or compatible with) the appropriate thread root dimensions by a specified order of magnitude, consistent with the desired scope of processing coverage. Laser shock processing treatment therefore facilitates precise and pinpoint delivery of laser beam energy to enable the formation of laser shock processed surfaces in areas of the threaded surface that are otherwise difficult or impossible to access with other shot process media.

Referring now to FIG. 3, there is shown a fragmentary, cross-sectional profile view of a sawtooth-type thread pattern 50 (e.g., unified thread) that is subject to a laser shock processing treatment, according to one form of the invention.

As shown, the thread root of thread pattern 50 is defined by a surface line 52 where opposing flanks 54, 56 of respective adjacent thread ridges 58, 60 meet.

According to the invention, the thread root (i.e., thread surface line 52) is laser shock processed using a suitable laser shock processing treatment, as illustrated by the collection of representative laser beams 62 irradiating flank surfaces 54 and 56. As a result, laser shock processed surfaces 64 and 66 are formed on flank surfaces 54 and 56, respectively. Additionally, a region of deep compressive residual stress 70 imparted by the laser shock processing is formed, which extends into the thread body from laser shock processed surfaces 64 and 66. As shown, the stress region 70 extends contiguously from one flank to another through the area below the thread root (i.e., thread surface line 52).

The region of deep compressive residual stress bridges the gap created by conventional shot peening since the dimensions of the laser beam photons are significantly small compared to the physical dimensions of the workpiece being processed, there is no possibility of leaving any untreated areas as with conventional shot peening media.

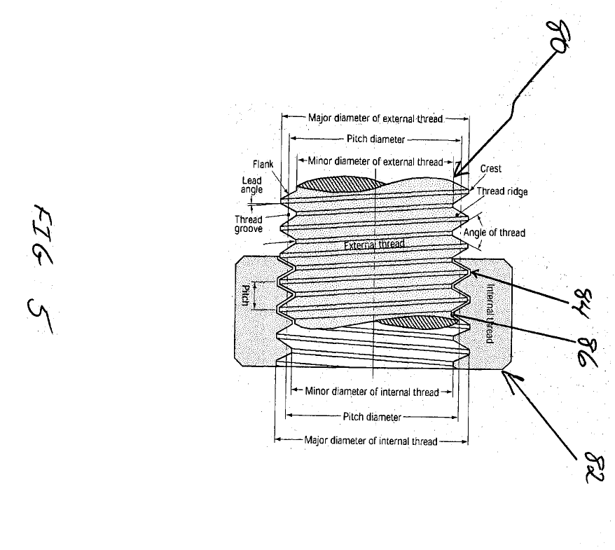

Referring to FIG. 4, there is shown a fragmentary upper planar view of thread pattern 50 in FIG. 3, to illustrate the effects of the laser shock processing treatment. According to one illustrative laser shock process, a suitable laser beam spot pattern may be used to produce the array of laser shock processed surfaces 72 depicted in FIG. 4. As shown, a central line of processed surfaces 74 is bordered by adjacent lines of processed surfaces 76 and 78. In one form, the central processed surfaces 74 bridge both of the adjacent flanks 54 and 56 at their lower ends while covering thread root surface line 52 The processed surfaces 76 and 78 are generally disposed along respective surfaces of flanks 54 and 56.

As with the laser shock processing treatment depicted in FIGS. 1 and 2, the parameters of the laser shock processing treatment shown in FIGS. 3 and 4 may be varied to encompass any type and extent of thread coverage. In addition, if pitting of the flanks of the thread causing failure by fatigue or wear is the problem to be mitigated, then the flanks up to the top of the ridge would be laser peened only, or in addition to the threads. Additionally, patterns of laser shock processed surfaces other than the one depicted in FIG. 4 may be used in practicing the invention. Accordingly, the illustration shown in FIG. 4 is for exemplary purposes only and should not be considered in limitation of the invention.

FIG. 3 is especially notable because it depicts the manner in which the laser beam 62 may access the abrupt junction that defines the meeting point of adjacent flanks 54 and 56 at thread root surface line 52. With other non-laser processing media, it would not be possible to access this sharp discontinuity in the threaded surface. Again, the precise scaling of the laser beam spot size to very small dimensions allows the treatment procedure disclosed herein to laser shock process this linear-type surface contour, namely, thread root line 52.

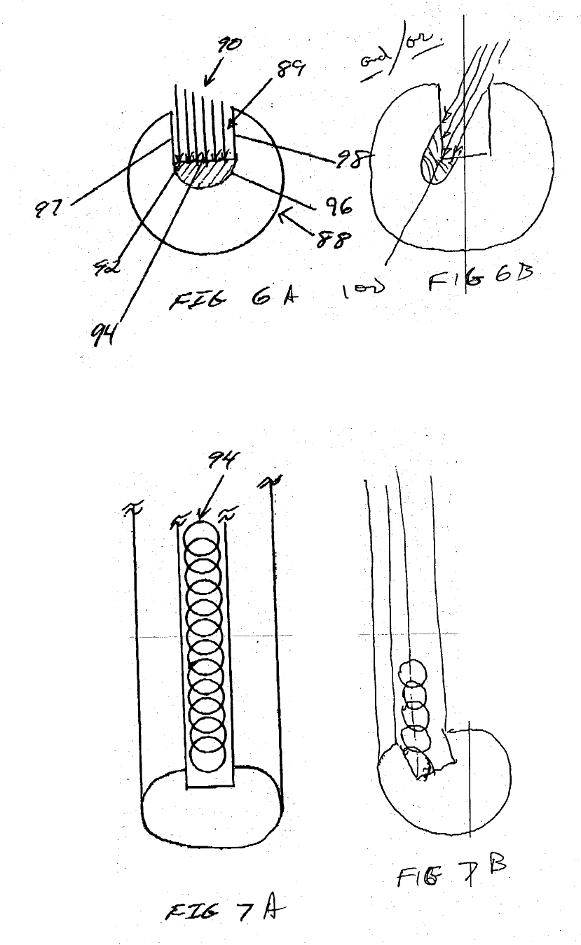

Referring now to FIG. 5, there is shown a side axial sectional view of an assembly of matable parts that can be used in connection with practicing the invention. In particular, there is shown in fragmentary section a male-type screw member 80 and a female-type screw member 82 configured together in a conventional threaded mating engagement. As shown, the external threaded surface of male screw 80 is disposed in threaded engagement with the internal threaded surface of female screw 82.

According to the invention, prior to assembly, one or both of screw members 80, 82 may undergo laser shock processing treatment to laser shock process thread root 84 of female screw 82 and thread root 86 of male screw 80, in a manner similar to that prescribed in connection with FIGS. 1-4. This treatment is preferably performed in each screw member at least along the full length of expected engagement.

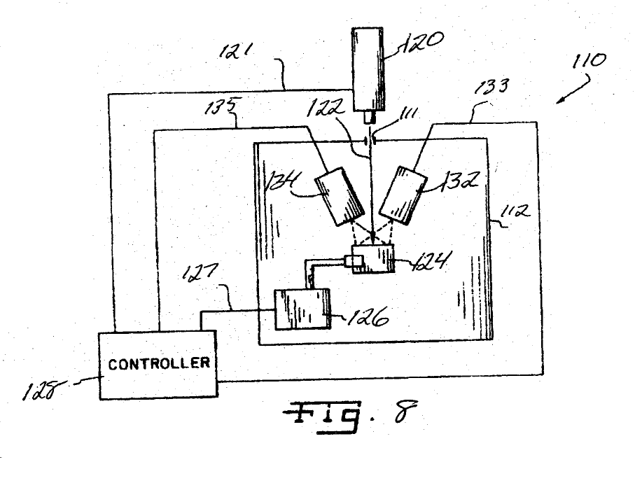

Referring now to FIG. 6, there is shown an axial end view of a shaft 88 having a keyway 89 formed therein along its longitudinal axis, to illustrate another form of the present invention. FIG. 7 depicts an upper plan sectional view of shaft 88 along its longitudinal dimension to illustrate the effects of the laser shock processing treatment as performed on keyway 89.

Referring to FIG. 6, in accordance with the invention, a collection of laser beams 90 irradiate the bottom surface 92 and corners 100 of keyway 89 to thereby produce a pattern of laser shock processed surfaces for example surface 94 (FIG. 7) configured along the axial dimension of keyway 89. Moreover, the laser shock processing treatment induces the formation of regions of compressive residual stresses 96 that extend into shaft 88 from a laser shock processed surface 94. Processing may also be utilized to form compressive residual stresses between sidewall surfaces 97, 98 and corners 100.

As with the laser shock processing treatments depicted in FIGS. 1-4, various aspects of the treatment procedure pertaining to FIGS. 6 and 7 can be modified and adjusted to meet any design and processing objective. For example, patterns of laser shock processed surfaces other than the one depicted in FIG. 7 can be generated by any appropriate laser beam spot pattern.

Although FIG. 6 depicts a laser shock process that treats the bottom surface 92 and corner 100 of keyway 89 along which a complementary mating key will be positioned, it may be possible with the invention to laser shock process any of the various surfaces of keyway 89. For example, the sidewall surfaces 97 and 98 of keyway 89 may be laser shock processed in a similar manner.

Again, the use of laser shock processing to selectively process some or all of keyway 89 (e.g., bottom surface 92) is facilitated by the precision and high-directivity of laser beam transmissions. In particular, the laser beam size and directivity can be precisely and reproducibly controlled to enable pinpoint laser shock processing of very small dimensional areas. The highly directional nature of laser beam transmissions also ensures the likelihood that the intended target area will be irradiated. This directional control may be implemented by any conventional means known to those skilled in the art.

Although a square-type keyway is shown in FIG. 6, this example should not be considered in limitation of the present invention, as it should be apparent that the invention may be practiced in connection with any keyway geometry, e.g., circular. Additionally, although the keyway of FIG. 6 has an open side, the invention may be practiced with keyways having different boundary topologies. For example, a bounded keyway such as a cylindrical-shaped pin-receiving bore may be used in connection with the invention. For this purpose, appropriate beam guidance mechanisms known to those skilled in the art may be used to adequately direct the laser beams into the pin-receiving bore to perform the laser shock processing operation on the bore surface.

It is preferable that the keyway experience laser shock processing along its entire longitudinal dimension, but particularly along the area where failure or weakness of the part originates. It should be apparent that any selected portion of the keyway may be laser shock processed.

Moreover, in a key-keyway combination, the invention may be practiced by laser shock processing both the key and its corresponding keyway, in a manner similar to that described herein.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A treatment method, comprising the steps of:
providing a workpiece having a threaded surface; and
laser shock processing at least one threaded portion of said workpiece.

2. The treatment method as recited in claim 1, wherein the laser shock processing step further includes the step of:
laser shock processing the at least one thread root portion of said workpiece to facilitate the formation of at least one region of compressive residual stresses each extending into said workpiece from a respective laser shock processed surface thereof.

3. The treatment method as recited in claim 1, wherein said workpiece defining at least one of a screw and a bolt.

4. The treatment method as recited in claim 1, wherein said workpiece defining a male member having an external threaded surface and/or a female member having an internal threaded surface.

5. A treatment method, comprising the steps of:
providing a workpiece having a threaded surface; and
forming at least one laser shock processed surface each disposed at least in part at a respective thread root portion of said workpiece.

6. The method as recited in claim 5, wherein the forming step further includes the step of:
forming at least one region of compressive residual stresses imparted by laser shock processing, each compressive residual stress region extending into the workpiece from a respective laser shock processed surface thereof.

7. A treatment method, comprising the steps of:
providing a workpiece having a threaded surface; and
causing the formation of at least one region of compressive residual stresses each extending into said workpiece at a respective thread root portion of said workpiece.

8. The treatment method as recited in claim 7, wherein the step of causing the formation of at least one region of compressive residual stresses further includes the step of:
laser shock processing said workpiece.

9. A method for use with a workpiece having a threaded surface, said method comprising the steps of:
providing a laser shock processor; and
operating said laser shock processor to laser shock process at least one thread root portion of said workpiece.

10. The method as recited in claim 9, wherein the laser shock process operation involves laser shock processing.

11. The method as recited in claim 9, wherein the operation of said laser shock processor being configured to facilitate the formation of at least one region of compressive residual stresses each extending into the workpiece from a respective laser shock processed surface thereof.

12. The method as recited in claim 9, wherein said workpiece defining at least one of a male member having an external threaded surface, a female member having an internal threaded surface, a bolt, a screw and a nut.

13. A treatment method, comprising the steps of:
providing a workpiece having a threaded surface; and
laser shock processing said workpiece at least one thread trough portion of the workpiece threaded surface.

14. The treatment method as recited in claim 13, wherein the step of laser shock processing said workpiece further includes the step of:
laser shock processing at least one thread root portion of said workpiece.

15. The treatment method as recited in claim 13, wherein the step of laser shock processing said workpiece further includes the step of:
forming at least one laser shock processed surface each disposed at least in part at a respective thread root portion of said workpiece.

16. The treatment method as recited in claim 13, wherein the step of laser shock processing said workpiece further includes the step of:
causing the formation of at least one region of compressive residual stresses imparted by laser shock processing, each compressive residual stress region extending into said workpiece at a respective thread root portion of said workpiece.

17. The treatment method as recited in claim 13, wherein the at least one thread trough portion of said workpiece experiencing laser shock processing includes at least one thread root portion.

18. A system for use with a workpiece having a threaded surface, said system comprising:
a laser shock processing apparatus; and
a controller to selectably control operation of said laser shock processing apparatus;
said controller being operably configured to direct said laser shock processing apparatus to laser shock process at least one thread root portion of said workpiece.

19. The system as recited in claim 18, wherein the laser shock processing of said workpiece by said laser shock processing apparatus being effectual in facilitating the formation of at least one region of compressive residual stresses each extending into said workpiece from a respective laser shock processed surface thereof.

20. A system for use with a workpiece having a threaded surface, said system comprising:
a laser shock processing apparatus; and
a controller to selectably control operation of said laser shock processing apparatus;
said controller being operably configured to direct said laser shock processing apparatus to laser shock process said workpiece to form at least one laser shock processed surface each disposed at least in part at a respective thread root portion of said workpiece.

21. An article having a threaded surface, said article comprising:
at least one laser shock processed surface each disposed at least in part at a respective thread root-portion of said article; and
at least one region each having compressive residual stresses imparted by laser shock processing, each region extending into said article from a respective laser shock processed surface.

22. The article as recited in claim 21, further includes at least one of a male member having an external threaded surface, a female member having an internal threaded surface, a bolt, a screw, and a nut.

23. A treatment method, comprising the steps of:
providing a workpiece having a keyway; and
laser shock processing at least a portion of the workpiece keyway.

24. The treatment-method as recited in claim 23, wherein the laser shock processing step further includes the step of:
laser shock processing the workpiece keyway to form at least one laser shock processed surface thereof and to form at least one region of compressive residual stresses imparted by laser shock processing, each compressive residual stress region extending into said workpiece from a respective laser shock processed surface.

25. A treatment method, comprising the steps of:
providing a workpiece having a keyway; and
forming at least one laser shock processed surface each disposed at least in part within the workpiece keyway.

26. The treatment method as recited in claim 25, wherein the forming step further includes the step of:
forming at least one region of compressive residual stresses imparted by laser shock processing, each compressive residual stress region extending into said workpiece from a respective laser shock processed surface thereof.

27. A treatment method, comprising the steps of:
providing a workpiece having a keyway with a surface; and
laser shock processing said workpiece at the keyway surface thereof to form at least one laser shock processed surface and to form at least one region of compressive residual stresses imparted by laser shock processing, each compressive residual stress region extending into said workpiece from a respective laser shock processed surface thereof.

28. A system for use with a workpiece having a keyway, said system comprising:
a laser shock processing apparatus; and
a controller to selectably control operation of said laser shock processing apparatus;
said controller being operably configured to direct said laser shock processing apparatus to laser shock process the workpiece keyway.

29. The system as recited in claim 28, wherein the laser shock processing of said workpiece by said laser shock processing apparatus being effectual in facilitating the formation of at least one region of compressive residual stresses each extending into said workpiece from a respective laser shock processed surface thereof.

30. A system for use with a workpiece having a keyway, said system comprising:
a laser shock processing apparatus; and
a controller to selectably control operation of said laser shock processing apparatus;
said controller being operably configured to direct said laser shock processing apparatus to laser shock process said workpiece to form at least one laser shock processed surface each disposed at least in part within the workpiece keyway.

31. An article having a keyway, said article comprising:
at least one laser shock processed surface each disposed at least in part within the keyway of said article; and
at least one region each having compressive residual stresses imparted by laser shock processing, each region extending into said article from a respective laser shock processed surface.

32. A method for use with an assembly having a combination of matable parts, each matable part having a respective mating surface, said method comprising the steps of:
laser shock processing at least a portion of the mating surface of at least one matable part.

33. The method as recited in claim 32, wherein said assembly includes a workpiece having a threaded surface.

34. The method as recited in claim 33, wherein the laser shock processing step further includes the step of:
laser shock processing at least one thread root portion of said workpiece.

35. The method as recited in claim 32, wherein said assembly includes a workpiece having at least one of a key or a keyway.

36. The method as recited in claim 35, wherein the laser shock processing step further includes the step of:
laser shock processing at least a portion of said workpiece key or keyway.

37. An article having a combination of matable parts, each matable part having a respective mating surface, said article comprising:
at least one laser shock processed surface each disposed at least in part at a respective mating surface of a respective matable part; and
at least one region each having compressive residual stresses imparted by laser shock processing, each region extending into said article from a respective laser shock processed surface.

38. The article as recited in claim 37, further includes at least one matable part each having a threaded surface with at least one laser shock processed surface formed at a thread root thereof.

39. The article as recited in claim 37, further includes at least one matable part each having a keyway with at least one laser shock processed surface formed therein.
